(19) United States
(12) Patent Application Publication
(10) Pub. No.: US 2010/0332270 A1
(43) Pub. Date: Dec. 30, 2010

(54) STATISTICAL ANALYSIS OF DATA RECORDS FOR AUTOMATIC DETERMINATION OF SOCIAL REFERENCE GROUPS

(75) Inventors: Yossi Richter, Haifa (IL); Elad Yom-Tov, Haifa (IL)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 12/494,314

(22) Filed: Jun. 30, 2009

(51) Int. Cl. G06Q 10/00

(52) U.S. Cl. 705/7

(57) ABSTRACT

A social reference group of a set of customers may be determined based on the interaction of customers. Using a portion of database of a service provider, interactions between customers may be determined. The interactions are analyzed to provide an at least one social reference group. A social reference group comprises a portion of the set of customers that are deemed socially similar. A behavior of a customer may be predicted based on past interactions and/or properties of the social reference group. The predicted behavior may be prevented by performing an action such as for example offering a customer about to churn an improved deal.

### BACKGROUND

The present disclosure relates to customer predication, and to customer predication based on statistical analysis of customer interaction, in particular.

Many service providers, such as telecommunication service providers in general, and mobile telecommunication service providers in particular, gather diverse statistical information about an individual customer in order to predict his behavior, needs, requirements and the like. In some cases, an estimation of a possibility that the customer will stop being a customer of the service provider, also referred to as churn, is established and based on that estimation preventive measurements are taken. Some exemplary preventive measurements are to offer the customer a discount, an upgrade of the service and the like. Churn prediction is significant for many service providers in order to continue growing and increase their profits, churn rate should be minimized as attracting new customers usually requires investing in promotional content, advertisements, marketing and the like.

Although the present disclosure discusses in detail customers of cellular telecommunication services, it should be noted that the disclosed subject matter is not limited to such services. The disclosed subject matter may be utilized for any type of service in which customer to customer interactions are observed.

### BRIEF SUMMARY OF THE INVENTION

One exemplary embodiment of the disclosed subject matter is a computerized system comprising: a processor; an interface to a database; the database comprising an at least one data record; a portion of the at least one data record represents an interaction between two or more customers; a customer relation module for determining a social reference group of an at least one customer; the customer relation module comprising: a customer relation matrix module for determining a relation between customers based on a portion of the at least one data record; a density reducer module for determining an at least one relation between customers; a core social reference group module for determining the core social reference group based on the determination of the consumer relation matrix and the determination of the density reducer module; wherein the customer relation module determines the social reference group based on the core social reference group and the determination of the consumer relation matrix; and a properties extractor for extracting one or more properties attributed to the social reference group; the properties extractor utilizes the processor for the extracting one or more properties.

Another exemplary embodiment of the disclosed subject matter is a method comprising: retrieving an at least one data record from a database; a portion of the at least one data record represents an interaction between at least two customers; determining a social reference group of an at least one customer comprising: determining a relation between customers based on the at least one data record; determining a core social reference group based on a portion of the relation between customers; the portion of the relation between customers is attributed with a predetermined characteristic; determining the social reference group based on the core social reference group and the database; identifying one or more properties attributed to the social reference group; the identification is performed by a processor; and storing the one or more properties in a computer-readable media; whereby the one or more properties is attributed to an at least one customer.

Yet another exemplary embodiment of the disclosed subject matter is a computer program product comprising: a computer readable medium; first program instruction for retrieving an at least one data record from a database; a portion of the at least one data record represents an interaction between at least two customers; second program instruction for determining a social reference group of an at least one customer; the second program instruction comprising: third program instruction for determining a relation between customers based on the at least one data record; fourth program instruction for determining a core social reference group based on a portion of the relation between customers; the portion of the relation between customers is attributed with a predetermined characteristic; fifth program instruction for determining the social reference group based on the core social reference group and the database; sixth program instruction for identifying one or more properties attributed to the social reference group; and seventh program instruction for storing the one or more properties in a computer-readable media; wherein the first, second, third, fourth, fifth, sixth and seventh program instructions are stored on the computer readable media.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a computerized environment in which the disclosed subject matter is used, in accordance with some exemplary embodiments of the subject matter;

FIG. 2 shows a block diagram of a computerized system in accordance with some exemplary embodiments of the disclosed subject matter;

FIG. 3 shows a block diagram of a customer relation module in accordance with some exemplary embodiments of the disclosed subject matter; and

FIG. 4 shows a flowchart diagram of a method in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to identify a social reference group of customers based on existing data records. Another technical problem dealt with by the disclosed subject matter is to predict a behavior of a customer based on his interaction with a relevant social reference group. Yet another technical problem dealt with by the disclosed subject matter is to provide a churn prediction technique that enables a service provider to perform a preventive action to decrease a possibility of churn.

One technical solution is to determine a social reference group based on existing data records by identifying connected components in a sub-graph of a graph that represents the at least one interaction between customers. Another technical solution is to continuously monitor data records to predict a possibility of churn of a portion of a social reference group based on historical records and on a behavior of a customer. Yet another technical solution is to provide a connectivity measurement index to measure a relative importance of a connection between two customers based on their interactions with each other and with one or more additional customers; the connectivity measurement index enables to decrease a density of a graph spanned by the interaction between customers and/or to determine a leader of a social reference group.

One technical effect of utilizing the disclosed subject matter is an automatic determination of an action to perform in order to affect a behavior of a customer. Another technical effect is taking the aforementioned action. Yet another technical effect is an automatic customer behavior prediction system based on current behavior of a first set of customers and past behavior of a second set of customers. The customer behavior prediction system may be a churn prediction system.

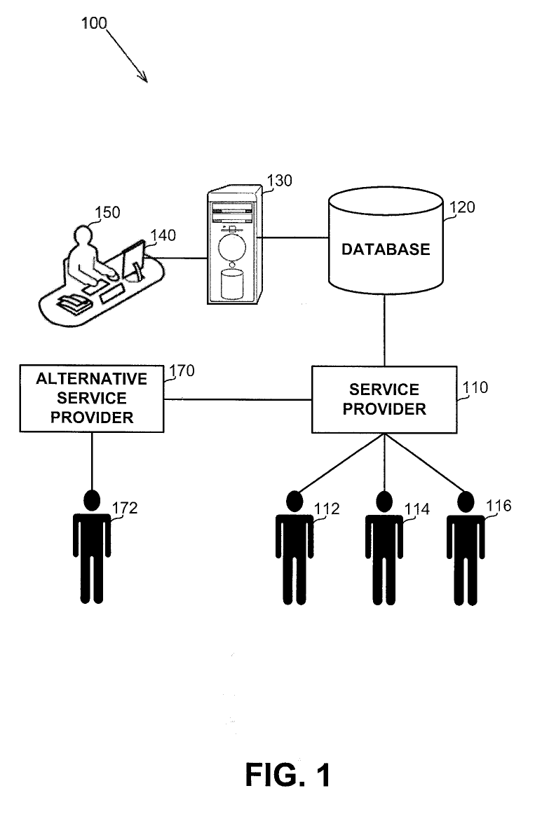

Referring now to FIG. 1 showing a computerized environment in which the disclosed subject matter is used, in accordance with some exemplary embodiments of the subject matter. A computerized environment 100 comprises a service provider 110, such as a telecommunication service provider, providing a service to customers 112, 114, 116. It will be noted that the service provider 110 may provide the service to many customers, such as thousands or millions of customers. It will be further noted that the service provider 110 may provide several types of specific services, such as a message communication, such as a Short Message Service (SMS), e-mail service and the like, a voice communication, such as a telephone call, Voice Over IP (VOIP) service and the like, a data communication service such as an TCP/IP connection, Wireless Application Protocol (WAP) connection and the like, or other services that enable a customer to interact with another customer, person, machine, device or the like.

A customer, such as the customer 112, receives a service provided by the service provider 110. It will be noted that in some exemplary embodiments, a first customer, such as customer 112, may receive a service, such as a telecommunication service, with a customer, such as customer 172, who is not a customer of the service provider 110. For example, a customer of the service provider may initiate a telephone call to a person who receives his telecommunication services from another service provider, such as an alternative service provider 170. It will be further noted that the customer may be a person, a machine such as for example an automated answering service, a computerized server, a device and the like.

The environment 100 may further comprise a database 120. The database 120 may store data records relating to a service provided by the service provider 110. A data record of the database 120 comprises information regarding an interaction between at least a first customer and a second customer. In an exemplary embodiment, the data record comprises information regarding an interaction between two or more customers, such as customers 112 and 114. For example, the data record may comprise information regarding a phone call such as for example, time of call, date of call, call duration, a customer initiation the call, one or more customers receiving the call and the like. In an alternative example, the data record may comprise information regarding an SMS message such as for example, message sending time, message arrival time, message content, a customer sending the message, one or more customers receiving the message and the like. In some exemplary embodiments of the disclosed subject matter, the database 120 is managed mainly for billing purposes or business intelligence purposes. The database 120 may be a Call Detail Record (CDR) database of the service provider 110.

In some exemplary embodiments of the disclosed subject matter, the environment further comprises a computerized server 130. The computerized server may have access to the database 120. In some exemplary embodiments, the server 130 monitors the content of the database 120 continuously to determine a prediction of a behavior of a customer such as customer 112. In another exemplary embodiment, the server 130 monitors the content of the database 120 upon request from a user 150, in predetermined times, such as for example at an end of a month, a specific time of a day, a month or a year, and the like. In some exemplary embodiments, the server 130 may perform an initial inspection of historic data records, such as for example all data records in the database 120, all records relating to a predetermined time window retained in the database 120 and the like. In some exemplary embodiments, the historic data records are retrained in an historical database (not shown). The initial inspection may enable the server 130 to predict the behavior of the customer 112 based on the historic data records and the content of the database 120.

In some exemplary embodiments, the user 150 of the server 130 utilizes a terminal 140 or a similar computerized device to access the server 130. The user 150 may determine a course of action based on the prediction of the server 130. Alternatively, in case the server 130 provides a suggested course of action, the user 150 may decide to abandon, modify or perform the suggested course of action. An exemplary suggested course of action is to contact a customer, such as customer 116, and offer the customer a gift, a reduced rate, an upgraded contract, an upgrade of services and the like. The exemplary suggested course of action may be directed to cause the customer 116 or another customer, such as the customer 112, to eventually not perform a predicted behavior or to perform a different behavior. In some exemplary embodiments, the suggested course of action may be related to a leader customer. It will be noted that the leader customer may not be characterized by a leadership skill, a position in a hierarchical structure or the like. The leader customer is defined by the disclosed subject matter as a customer having a highest relative importance in a reference social group. It will be further noted that the leader customer may be determined by the server 130 based on the interaction between him and other members of a social reference group.

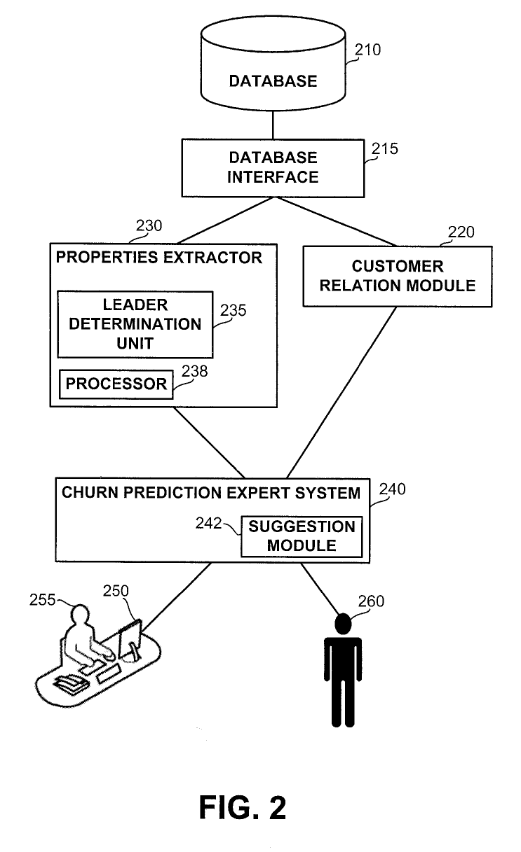

Referring now to FIG. 2 showing a block diagram of a computerized system in accordance with some exemplary embodiments of the disclosed subject matter.

A database 210, such as database 120 of FIG. 1, comprises one or more data records which comprise information regarding an interaction between a first customer and a second customer.

In an exemplary embodiment of the disclosed subject matter, a database interface 215 provides an interface to the database 210. The database interface 215 may be a third-party device, a data management system, an Application Program Interface (API) and the like. In some exemplary embodiments, the database interface 215 provides also an interface to an historical database.

In some exemplary embodiments of the disclosed subject matter, a customer relation module 220 determines a social reference group based on a portion of the data records in the database 210. The portion of the data records may be predetermined by a user (not shown), characteristics, rules and the like. For example, the portion of the data records may be a specific set of data fields of the data records. Alternatively, the portion of the data records may be a set of data fields of all data records relating to a predetermined time window.

In an exemplary embodiment, a social reference group comprises a core social reference group of customers that are relatively strongly connected with each other. It will be noted that the strength of a connection between two customers is not a matter of physical strength but rather an indication of the characteristic of an interaction between the two customers and their interactions with other customers. For example, a first customer may be considered strongly connected to a second customer if the first customer interacts with the second customer and/or if the first and second customers interact with a relatively similar group of customers. An interaction may be a, for example, initiating a phone call, at least a predetermined number of times, at a predetermined rate, the first customer interacts at least a predetermined portion of interactions with the second customer or a customer of the group of customers and the like. In an exemplary embodiment of the disclosed subject matter, the core social reference group may be determined by the customer relation module 220 depending on a graph representing the relations between customers as is further detailed below. In some exemplary embodiments, the customer relation module 220 is configured to disregard a portion of the edges of the graph based on a predetermined property of the edge. For example, an edge having a weight below a predetermined threshold may be disregarded by the customer relation module 220 for determining the core social reference group.

In some exemplary embodiments of the disclosed subject matter, a properties extractor 230 identifies or otherwise determines an at least one property attributed to a social reference group. Some exemplary non-limiting properties are the following: number of members in the social reference group, density in a group graph (as defined below), density in a core group graph (as defined below), number of members in the core social reference group, fraction of members of the core social reference group from the members of the social reference group, an importance measurement of a member, ratio between an importance measurement of a first member and an importance measurement of a second member, a highest importance measurement of a member in the social reference group, a lowest importance measurement of a member in the social reference group, average number of outgoing edges or incoming edges in the group graph or in the core group graph, average number of interactions between members of the social reference group and customers that are not members of the social reference group, average number of predetermined interactions of a predetermined customer/consumer, such as a leader consumer.

It will be noted that the above is a non-limiting exemplary list of properties. Some additional properties may be determined by normalizing, determining an average, a median and other mathematical computations on the aforementioned properties or other similar properties. Some exemplary properties are defined such that a change in the properties correlates to a changed behavior of a customer. For example, in a telecommunications system targeting to predict churn possibilities, a decrease in a number of SMS messages sent to a leader customer may correlate a desire of a portion of the customers of the social reference group to churn from the telecommunication service provider. It will be noted that a combination of several properties may correlate with a change of behavior. It will be further noted that the correlation may be determined by a computerized system, such as an expert system 240 and may be based on assumptions that are not tested or based on any evidence. For example, one may assume that a decrease in several types of interactions between the members of the social reference group may correlate with an intention to churn. Additionally, a decrease in average number of interactions between members of the social reference group with customers/consumers from outside the social reference group may correlate to a high churn rate of the social reference group in the future.

The group graph of a social reference group is a graph comprising a vertex for each member of the social reference group and a weighted directed edge between a first member and a second member representing an at least one interaction between the first and second members. In some exemplary embodiments, the graph is a directed graph and the direction of an edge is based on the member that initiated the interaction. In some exemplary embodiments, the weight of the edges is a function of a predetermined attribute of an interaction between the first customer and second customer. For example, the weight may be a number of interactions between the first and second customers, duration of interactions, a function of the content of the interaction, such as for example number of times a predetermined word appears in a message, and the like. There may be several types of edges for different interactions, such as SMS, phone calls, data communication and other types of communications, a combination thereof and the like. A core group graph is a similar graph which relates only to the core social reference group.

A density of a graph is a fraction of edges out of the possible edges. For example, for a directed graph of N vertices, there are N(N−1) possible directed edges.

In some exemplary embodiments of the disclosed subject matter, the properties extractor 230 comprises a leader determination unit 235 for determining a leader customer of a social reference group, also referred to as a leader. It will be further noted that a leader customer may not be characterized by a leadership skill, a position in a hierarchical structure or the like. The leader customer is defined by the disclosed subject matter as a customer having a highest relative importance in a reference social group. The importance of a customer is based on predetermined characteristics, attributes, properties, rules, the combination thereof and the like. For example, the importance of a customer may be measured by the number of incoming edges to a corresponding vertex in the group graph. Alternatively, an importance of each customer may be determined based on its relative distance from other members in the social reference group. The distance may be, for example, a number of edges between two members in the group graph. In an exemplary embodiment, an edge of the group graph between a first member and a second member is weighted with a probability that an interaction initiated by the first member targets the second member. For example, by determining a fraction of interactions that the first member initiated based on historic data or past behavior, the aforementioned probability may be determined. In such an exemplary embodiment, an importance of a customer may be a multiplication of the weighted edges between two customers. The importance may be determined using random walks over the group graph with restarts, multiplying a probability matrix representing the group graph until a stationary matrix is determined, determining eigenvalues for the customers and the like.

In some exemplary embodiments of the disclosed subject matter, the properties extractor 230 may further comprise a processor 238. The processor 238 is a Central Processing Unit (CPU), a microprocessor, an electronic circuit, an Integrated Circuit (IC) or the like. The processor 238 may be utilized to perform computations required by the properties extractor 230 or any of it subcomponents, such as for example the leader determination unit 235. In some exemplary embodiment, a second processor may be utilized by another component of the system, such as for example the customer relation module 220, the expert system 240 and the like.

In some exemplary embodiments of the disclosed subject matter, an expert system 240, such as a computerized artificial intelligence device, a machine learning device, a software implementation of an expert system and the like, predicts a behavior of a customer 260 based on the properties extracted by the properties extractor 230. In an exemplary embodiment, the export system 240 inspects an historic database, such as for example an historic database of about two weeks to learn a behavior of consumers and monitors a current database, such as for example the database 210, of about three latest days to predict a behavior of the customer 260. The expert system 240 may comprise a suggestion module 242 for suggesting an action to be taken to prevent the predicated behavior of the customer 260. In some exemplary embodiments, the suggestion module 242 may further perform the action to be taken. In an exemplary embodiment of the disclosed subject matter, the expert system 240 is a churn prediction expert system which is configured to predict churn probability based on the properties extracted by the properties extractor 230.

In some exemplary embodiments of the disclosed subject matter, a user 255 of the expert system 240 receives an indication using a terminal 250 regarding the predicted behavior 260. In some exemplary embodiments, the user 255 is a customers' relation personnel which receives an indication that a customer is about to churn (i.e., stop being a customer). The user 255 may take an action based on the prediction or based on a suggested action determined by the expert system 240.

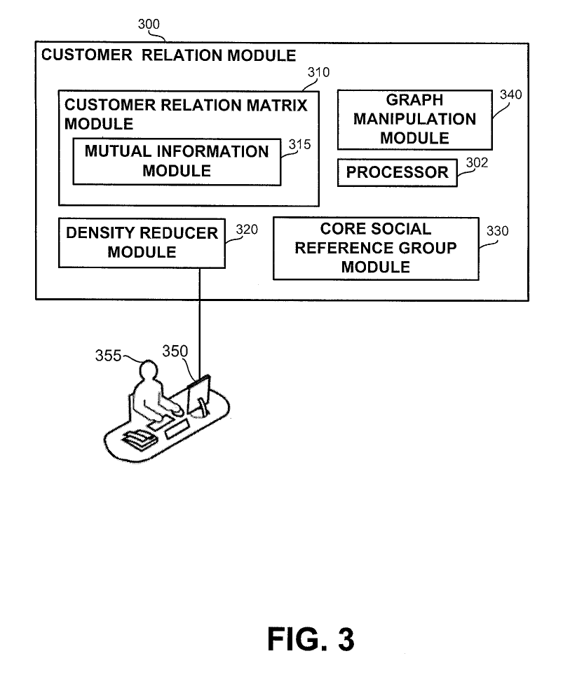

Referring now to FIG. 3 showing a block diagram of a customer relation module in accordance with some exemplary embodiments of the disclosed subject matter. A customer relation module 300, such as 220 of FIG. 2, may comprise a customer relation matrix module 310, a graph manipulation module 340, a density reducer module 320, a processor 302 and a core social reference group module 330.

In some exemplary embodiments of the disclosed subject matter, the processor 302 is a CPU, IC, microprocessor or the like such as processor 238 of FIG. 2.

In some exemplary embodiments of the disclosed subject matter, the customer relation matrix module 310 determines a probability matrix in respect to a portion of the customers. The probability matrix may determine a likelihood that a first customer may interact with a second customer. In an exemplary embodiment, the likelihood is determined based on historic data, past information and the like. In an exemplary embodiment the customer relation matrix module 310 determines a probability matrix based on a portion of the interactions between two or more customers. The portion may be determined based on characteristics such as for example type of interaction, time of interaction, duration of interaction and the like. In an exemplary embodiment, a probability that a first customer will interact with a second customer is determined based on the proportion between a number of interactions the first customer had with the second customer and a total number of interactions the first customer had. It will be noted that in some exemplary embodiments, the interactions may be counted in respect to their duration, type or other characteristics.

In some exemplary embodiments, the customer relation matrix 310 further comprises a mutual information module 315. The mutual information module 315 may determine a relation between a first customer and a second customer based on a set of additional customers the first customer and the second customer interact with. In some exemplary embodiments, a first customer and a second customer interacting with a relatively similar set of customers are considered socially related. In an exemplary embodiment of the disclosed subject matter, the mutual information module 315 is configured to determine social relation between the first and second customer based on a portion of the interactions of the first and second customer, such as for example a hundred latest interactions of the first and second customer, interactions performed in a predetermined timeframe, such as last three days, a combination thereof and the like.

In an exemplary embodiment of the disclosed subject matter, the mutual information module 315 may determine a vector associated with each customer identifying an additional customer that the customer interacted with. The mutual information module 315 may further determine a count matrix associated with a first customer and a second customer. The count matrix may indicate a number of additional customers that both the first and second customers interacted with. The count matrix may indicate a number of an at least one additional customer that only one of the first and second customers interacted with. The count matrix may be further normalized, for example, by the size of the vector. The count matrix may be seen as representing a joint distribution. The joint distribution may represent a probability that the first customer and the second customer both interact with a specific customer. Based on the joint distribution, the mutual information module 315 may determine similarity between the first and second customers via the mutual information contained in the joint distribution.

In an exemplary embodiment, the customer relation matrix 310 may determine that a matrix representing a social similarity between a first customer and a second customer based on the similarity determined by the mutual information module 315. The first customer and the second customer may be determined to be socially connected in case a similarity score determined by the mutual information module 315 is higher than a predetermined threshold, in a certain percentile, such as the highest ten percent, and the like.

The density reducer module 320 may determine a portion of the edges of a customers graph that are not to be included in the core group graph. The customers graph may be a graph comprising a vertex for each customer and a weighted edge representing an interaction between two customers or a social similarity between two customers. It will be noted that the weighted edge may represent one or more interactions. It will be further noted that the weight may be a function of one or more properties of the one or more interactions, such as for example the duration of the interactions, the portion of the interactions out of the total interaction of the customer and the like. The weight of the edge may represent a duration of interactions between two customers, a proportional duration, a function of the types of interactions and the like. It will be further yet noted that in case an interaction is initiated by a first customer and is directed to a second and third customer, that interaction may be represented by a first edge connecting the first customer and the second customer and a second edge connected the first customer and the third customer. In an exemplary embodiment, the density reducer module 320 may make aforementioned determination for an edge based on a weight of the edge and on a predetermined threshold. In an exemplary embodiment, the predetermined threshold may be a predetermined minimal weight, a predetermined minimal percentile between all outgoing edges from a vertex and the like. A customers graph that does not comprise the edges that are determined by the density reducer module 320 is referred to as a sparse customer graph.

In some exemplary embodiments, the density reducer module 320 may receive an indication of a threshold from a user such as user 355 via a computerized device such as a terminal 350. In another exemplary embodiment, the user 355 may manually indicate one or more edges to be removed from the sparse customer graph.

The core social reference group module 330 determines a core group graph based on the sparse customers graph. The core social reference group module 330 may utilize the graph manipulation module 340 to partition a reduced customers graph into a set of one or more connected components. Each connected component is considered a core social reference group. In some exemplary embodiments of the disclosed subject matter, the core social reference group module 330 further determines a social reference group based on the core social reference group. The social reference group may comprise all customers in the core social reference group. In some exemplary embodiments, the social reference group further comprises additional customers that are not associated with any other core social reference group. For example, a customer may be included in a social reference group that the customer interacted most with, that the customer initiated an interaction with and the like. In some exemplary embodiments, the core social reference group module 330 iteratively selects a customer not associated with any core social reference group and associates the customer with a social reference group. The selection of the customer may be performed based on predetermined rules, parameters or characteristics such as for example a customer with a largest number of interactions, having an associated edge with a highest weight and the like.

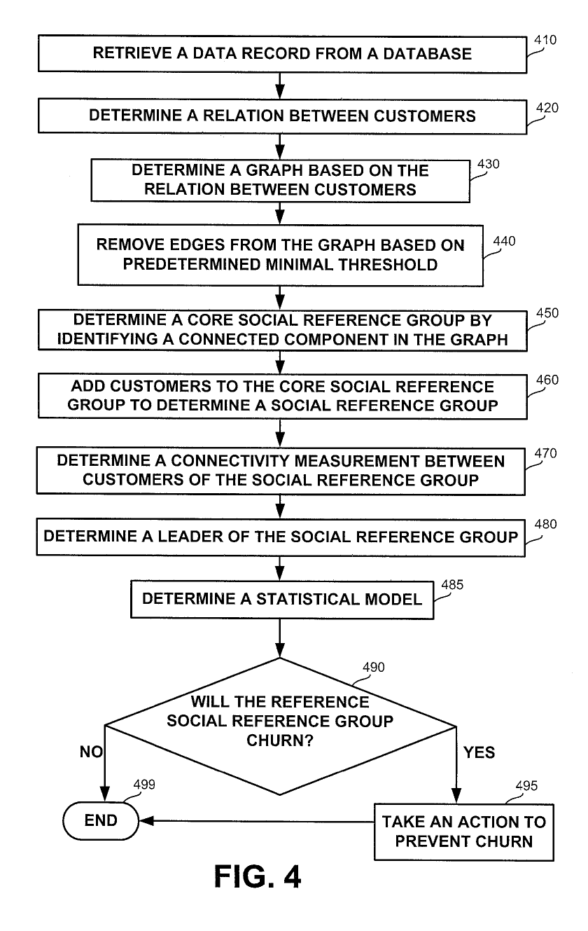

Referring now to FIG. 4 showing a flowchart diagram of a method in accordance with some exemplary embodiments of the disclosed subject matter.

In step 410 a data record is retrieved from a database, such as database 210 of FIG. 2. In an exemplary embodiment, the data record comprises information regarding an interaction between at least a first customer and a second customer. In an exemplary embodiment, a portion of the data record is retrieved. In another exemplary embodiment, the retrieval is performed by a database interface such as for example database interface 215 of FIG. 2. In yet another exemplary embodiment, the data record is retrieved from an historical database.

In step 420, a relation between a first customer and a second customer is determined. The relation is determined based on the data record retrieved in step 410. The relation may represent a social similarity between a first and a second customer, such as for example based on an interaction with a similar set of customers. The relation may represent a likelihood that the first customer will initiate an interaction with the second customer, a likelihood that an interaction between the first customer and second customer will occur, an average duration of an interaction between the first customer and second customer, a total duration of all interactions represented by a one or more data records retrieved in step 410 that relate to the first customer and second customer, a probability that an interaction of the first customer will be with the second customer or the like. In an exemplary embodiment, there may be several types of interactions and the relation may represent a portion of the interactions in respect to type or a function of different parameters of different interaction types. For example, the relation may represent the total of data bytes passed between the first customer and second customer in a data call and a total of the duration type of all phone calls between the first customer and second customer or the like.

In step 430, a graph representing the relation determined in step 420 is determined. In an exemplary embodiment, the graph comprises one or more vertices and one or more edges. A vertex may represent a customer. An edge may represent a relation between a first customer and a second customer. An edge may be attributed with a weight retaining a representation of the strength of the relation between the first customer and the second customer. It will be noted that in some exemplary embodiments, different data types may represent the data retained by the aforementioned exemplary graph, also referred to as a customer graph.

In step 440 one or more edges are removed from the customer graph or other data structure determined in step 430. The one or more edges are attributed with a weight lower than a predetermined minimal threshold which may be a predetermined minimal weight, a predetermined lower percentile or the like. In an exemplary embodiment, a user may determine manually the one or more edges or a portion of the one or more edges. In another exemplary embodiment the one or more edges are determined by a density reducer module such as the density reducer module 320 of FIG. 3. A graph is the customer graph without the edges determined to be removed in step 440 is referred to as a sparse customer graph. It will be noted that the sparse customer graph may be represented by a data structure which is not a graph, such as for example one or more arrays.

In step 450, the sparse customer graph is partitioned to one or more connected components. A one or more core social reference group is associated with the one or more connected components.

In step 460, one or more social reference groups are determined based on the one or more core social reference groups. A customer which is not associated with any core social reference group may be associated with a social reference group based on the interaction between the customer and other members of the social reference group. In an exemplary embodiment, step 460 comprises creating a social reference group based on a core social reference group. Step 460 may further comprise iteratively selecting a customer not associated with any social reference group and adding the customer to a social reference group. The social reference group is a social reference may be characterized by having a relatively strong relation with the customer. A strength of a relation between a customer and a social reference group may be a function of the relations between the members of the social reference group and the customer. For example, it may be indicated by a positive number representing the total duration of interactions between the members of the social reference group and the customer, the average duration of interaction between the customer and the members of the social reference group and the like. In exemplary embodiment, in each iteration the selection of the customer is performed based on the predetermined rules, parameters of characteristics such as for example a customer having a strongest relative relation with a social reference group.

In step 470, a connectivity measurement between a first customer of the social reference group and a second customer of the social reference group is determined. In an exemplary embodiment, the determination is performed by a properties extractor such as properties extractor 230 of FIG. 2.

In step 480, a leader customer of a social reference group is determined based on the connectivity measurement determined in step 470. In an exemplary embodiment, the leader customer is the customer having a highest connectivity measurement of all the members of the social reference group. In an exemplary embodiment, the leader customer is determined by a leader determination unit such as the leader determination unit 235 of FIG. 2.

In an exemplary embodiment, a determination of a leader customer of a social reference group is made based on a normalized matrix representing the connectivity measurement between customers of the social reference group. The normalized matrix may be multiplied by itself until a stationary matrix is determined. The leader customer may be a customer having a predetermined attribute associated to it in the stationary matrix. It will be noted that in some exemplary embodiment other method may be utilized to determine the leader which are equivalent to determining a stationary matrix.

In step 485, a statistical model may be trained in accordance with the information extracted or determined in the previous steps. The statistical model may be a decision tree, a logistic regression, a Support Vector Machine (SVM), or the like. Training the model may be utilized to enable an expert system, such as the expert system 240 of FIG. 2, to predict behavior based on the information.

In step 490, a determination is made if according to current or past interactions a portion of a social reference group is expected to churn. It will be noted that not all members of the social reference group are customers of a first service provider, such as the service provider 110 of FIG. 1. In an exemplary embodiment of the disclosed subject matter, an expert system such as the expert system 240 of FIG. 2, performs step 490. The determination done by the expert system may be based on historical data, current data, predicted behavior, social research, marketing research or the like. In an exemplary embodiment, the statistical model is utilized in the determination. For example, the expert system may utilize the statistical model.

In case a portion of a social reference group is determined to be relatively highly likely to churn, step 495 is performed. In an exemplary embodiment, a suggestion module, such as suggestion module 242 of FIG. 2, suggest and action to prevent churn. In another exemplary embodiment, a suggestion may be made manually by a user such as marketing representative. In step 495, the action that may prevent the expected churn may be taken in order to prevent or otherwise increase a probability of preventing the churn. In an exemplary embodiment, the method is directed in order to achieve other goals which are not necessarily related to churn, such as for example increasing the income from the members of the social reference group or the like. It will be further noted that in some exemplary embodiments of the disclosed subject matter a suggested course of action is determined by a computerized device. However, a manual decision may be performed by a marketing representative or other personnel staff to determine whether to perform the suggested course of action, a different course of action or no course of action.

In an exemplary embodiment, in response to determining that no portion of any social reference group is about to churn in step 490, the method ends in step 499. In response to taking an action in step 495 the method may also end in step 499.

In some exemplary embodiments of the disclosed subject matter, an apparatus, system, product, process or the like may utilize the disclosed subject matter to achieve additional applications. An exemplary embodiment may be utilized to predict a group of people that are likely to respond to a campaign or a specific person to approach, such as for example a leader. An exemplary embodiment of the disclosed subject matter may determine a value associated with a customer based on a direct value from retaining the customer as a customer and based on an indirect value from retaining additional customers that may churn in response to a churn of the customer. An exemplary embodiment may determine a customer of a first service provider to contact that is likely to churn from the first service provider in order to attract the customer to be a customer of a second service provider. The determination may take in to account a direct value from the customer, an indirect value from a social reference group associated with the customer and the like.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computerized system comprising:
a processor;
an interface to a database; the database comprising an at least one data record; a portion of the at least one data record represents an interaction between two or more customers;
a customer relation module for determining a social reference group of an at least one customer; said customer relation module comprising:
a customer relation matrix module for determining a relation between customers based on a portion of the at least one data record;
a density reducer module for determining an at least one relation between customers;
a core social reference group module for determining the core social reference group based on the determination of said consumer relation matrix and the determination of said density reducer module;
wherein said customer relation module determines the social reference group based on said core social reference group and the determination of said consumer relation matrix; and
a properties extractor for extracting one or more properties attributed to the social reference group; said properties extractor utilizes said processor for said extracting one or more properties.

2. The computerized system of claim 1, wherein said density reducer module determines the at least one relation not to be used for determining a core social reference group based on a predetermined threshold.

3. The computerized system of claim 1, wherein said properties extractor is configured to determine a relative importance of a portion of the at least one customer in the social reference group to the social reference group.

4. The computerized system of claim 3, wherein said properties extractor determines a leader customer.

5. The computerized system of claim 4, wherein a customer relation matrix module determines a matrix and wherein said properties extractor determines a leader customer by determining a stationary matrix based on the matrix.

6. The computerized system of claim 1, wherein the one or more properties is selected from the group consisting of:
a size of the social reference group;
a number of customers of the social reference group who are customers of a service provider;
a ratio between the number of customers of the social reference group who are customers of the service provider and the size of the social reference group;
a social importance of a leader customer of the social reference group;
a social importance of a customer having a lowest social importance in the social reference group;
a ratio between a first social importance of a customer having a lowest social importance in the social reference group and a second social importance of a leader customer of the social reference group;
a number of interactions associated with a leader customer of the social reference group;
a number of interactions initiated by the leader customer;
a number of interactions designated to the leader customer;
an average number of interactions initiated by members of the social reference group;
an average number of interactions designated to members of the social reference group;
a number of interactions initiated by the leader customer normalized by the size of the social reference group;
a number of interactions designated to the leader customer normalized by the size of the social reference group;
an average number of interactions initiated by members of the social reference group normalized by the size of the social reference group;
an average number of interactions designated to members of the social reference group normalized by the size of the social reference group;
a size of the core social reference group;
a density of edges between members of the social reference group; and
an importance of a member of the social reference group.

7. The computerized system of claim 1, wherein said customer relation matrix further comprises a mutual information module; said mutual information module is configured to determine a score associated to a pair of customers; the pair of customers comprises a first customer and a second customer; the score is determined based on a portion of the at least one data record.

8. The computerized system of claim 7, wherein the service is a telecommunication service.

9. The computerized system of claim 8, wherein the telecommunication service is a mobile communication service; and wherein the interaction between two or more customers is selected from the group consisting of voice communication, messaging communication and data communication.

10. The computerized system of claim 9 further comprising an expert system for analyzing the one or more properties.

11. The computerized system of claim 10, wherein said expert system is a churn prediction expert system.

12. The computerized system of claim 10 wherein said expert system comprises a suggestion module.

13. The computerized system of claim 12 wherein said suggestion module is configured to suggest an action addressed to a leader customer of the social reference group.

14. The computerized system of claim 1, wherein said core social reference group module determines an at least one connected component of a graph representing the relation determined by said customer relation matrix module.

15. A method comprising:
retrieving an at least one data record from a database; a portion of the at least one data record represents an interaction between at least two customers;
determining a social reference group of an at least one customer comprising:
determining a relation between customers based on the at least one data record;
determining a core social reference group based on a portion of the relation between customers; the portion of the relation between customers is attributed with a predetermined characteristic;
determining the social reference group based on the core social reference group and the database;
identifying one or more properties attributed to the social reference group; said
identification is performed by a processor; and
storing the one or more properties in a computer-readable media;
whereby the one or more properties is attributed to an at least one customer.

16. The method of claim 15, wherein the one or more properties comprises a relative importance of a customer in the social reference group to the social reference group.

17. The method of claim 15 further comprises determining a leader customer of the social reference group.

18. The method of claim 17, wherein:
said determining the relation between customers determines a relation matrix between the customers; and
said determining the leader customer of the social reference group is performed by:
iteratively multiplying the relation matrix with itself until a stationary matrix is determined; and
determining a customer having a predetermined characteristic in the stationary matrix.

19. The method of claim 17, wherein the leader customer of the social reference group is characterized by having a minimal average distance on a relational customer graph from about all other customers of the social reference group; the relation customer graph is a graph representing the relation determined in said determining the relation between consumers.

20. The method of claim 17, further comprising determining an action to prevent the leader customer to churn.

21. The method of claim 15, wherein
said determining a relation between customers further comprises determining a connectivity measurement index; and
said determining a core social reference group is performed based on the portion of the relation between customers having a predetermined minimal measurement.

22. A computer program product comprising:
a computer readable medium;
first program instruction for retrieving an at least one data record from a database; a portion of the at least one data record represents an interaction between at least two customers;
second program instruction for determining a social reference group of an at least one customer; said second program instruction comprising:
third program instruction for determining a relation between customers based on the at least one data record;
fourth program instruction for determining a core social reference group based on a portion of the relation between customers; the portion of the relation between customers is attributed with a predetermined characteristic;
fifth program instruction for determining the social reference group based on the core social reference group and the database;
sixth program instruction for identifying one or more properties attributed to the social reference group; and
seventh program instruction for storing the one or more properties in a computer-readable media;
wherein said first, second, third, fourth, fifth, sixth and seventh program instructions are stored on said computer readable media.
